(19) United States
(12) Patent Application Publication
(10) Pub. No.: US 2014/0103595 A1
(43) Pub. Date: Apr. 17, 2014

(54) RELEASE STRUCTURE FOR A FIXTURE

(71) Applicant: Ching-Chen YANG, Taichung City (TW)

(72) Inventor: Ching-Chen YANG, Taichung City (TW)

(21) Appl. No.: 14/040,714

(22) Filed: Sep. 29, 2013

(30) Foreign Application Priority Data
Oct. 15, 2012 (TW) 101137904

(51) Int. Cl. B25B 11/00

(52) U.S. Cl. CPC B25B 11/00
USPC 269/136

(57) ABSTRACT

A release structure for a fixture contains: a support assembly including a first support arm, a second support arm, and a connecting rod; the connecting rod being inserted through the first support arm and the second support arm, such that a clamping space forms between the first support arm and the second support arm, and the first support arm having an abutting face so as to abut against the wooden workpiece; a force mechanism including a screw post screwing with the second support arm and a forcing post fitted with and rotating relative to the screw post. The screw post has a first inclined face to correspond to the forcing post and has a clamp head to mate with the wooden workpiece. The forcing post has a resilient element and a stop block. The stop block has a second inclined face to mesh with the first inclined face.

### FIELD OF THE INVENTION

The present invention relates to a release structure for a fixture, and more particularly to a release structure for a fixture which has a prestress releasing device by which an excessive clamping force is buffered so as to prevent a clamp arm of the fixture or a clamped wooden workpiece from damage.

### BACKGROUND OF THE INVENTION

As shown in FIG. 8, a conventional fixture for clamping a wooden workpiece is widely called as F-type fixture and contains a support assembly 3 and a screw post 4. The support assembly 3 is comprised of a first support arm 31, a second support arm 32, and a connecting rod 33. The connecting rod 33 is inserted through one end of the first support arm 31 and one end of the second support arm 32 so that a clamping space B forms between the first support arm 31 and a second support arm 32. The screw post 4 is screwed on the second support arm 32 and is rotated to move relative to the first support arm 31, hence the clamping space B is pressed or released to clamp or unclamp the wooden workpiece.

However, this conventional fixture is made of metal material, thus having a cumbersome defect. In particular, the first support arm and the second support arm are made of metal material, so in operation, the conventional fixture is operated inconveniently.

To improve such a problem, an improved fixture, made of plastic material, has been developed. Although such an improved fixture, made of plastic material, is operated conveniently, it is broken and damaged easily. In addition, its strength is weaker than that made of metal material.

The present invention has arisen to mitigate and/or obviate the afore-described disadvantages.

### SUMMARY OF THE INVENTION

The primary object of the present invention is to provide a release structure for a fixture which has a prestress releasing device by which an excessive clamping force is buffered so as to prevent a clamp arm of the fixture or a clamped wooden workpiece from damage.

To obtain the above objective, a release structure for a fixture provided by the present invention contains: a support assembly and a force mechanism.

The support assembly includes a first support arm, a second support arm, and a connecting rod. The connecting rod is inserted through one end of the first support arm and one end of the second support arm, such that a clamping space forms between the first support arm and the second support arm so as to place a wooden workpiece, and the first support arm has an abutting face defined on a bottom surface of another end thereof and facing to the clamping space so as to abut against the wooden workpiece.

The force mechanism includes a screw post screwing with another end of the second support arm and a forcing post fitted with and rotating relative to the screw post. The screw post has a first inclined face formed on a bottom end thereof so as to correspond to the forcing post and having a clamp head fixed on a top end thereof so as to mate with the wooden workpiece. The forcing post has a resilient element and a stop block, both of which are disposed in the forcing post and abut against each other. The stop block has a second inclined face defined on a top end thereof opposite to the resilient element and meshing with the first inclined face of the screw post.

Thereby, when rotating the forcing post, the first inclined face meshes with the second inclined face so as to drive the screw post to move, such that the clamping space is pressed or released so as to clamp or unclamp the wooden workpiece, and when an operation force is over a load range of the resilient element, the stop block presses the resilient element so that the first inclined face disengages from the second inclined face, hence the screw post stops clamping the wooden workpiece.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the exploded components of a release structure for a fixture according to a first embodiment of the present invention.

FIG. 2 is a perspective view showing the assembly of the release structure for the fixture according to the first embodiment of the present invention.

FIG. 3 is a cross sectional view showing the assembly of the release structure for the fixture according to the first embodiment of the present invention.

FIG. 4 is a cross sectional view showing the operation of the release structure for the fixture according to the first embodiment of the present invention.

FIG. 5 is another cross sectional view showing the operation of the release structure for the fixture according to the first embodiment of the present invention.

FIG. 6 is a perspective view showing the exploded components of a release structure for a fixture according to a second embodiment of the present invention.

FIG. 7 is a cross sectional view showing the operation of the release structure for the fixture according to the second embodiment of the present invention.

FIG. 8 is a perspective view of a conventional release structure for a fixture.

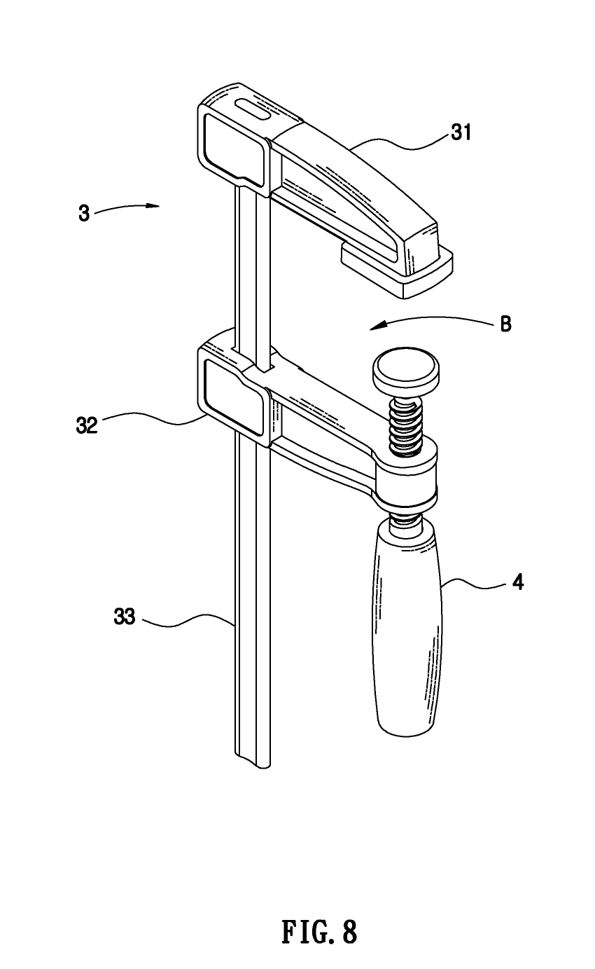

### DETAILED DESCRIPTION OF THE PREFERRED EMBODIMENTS

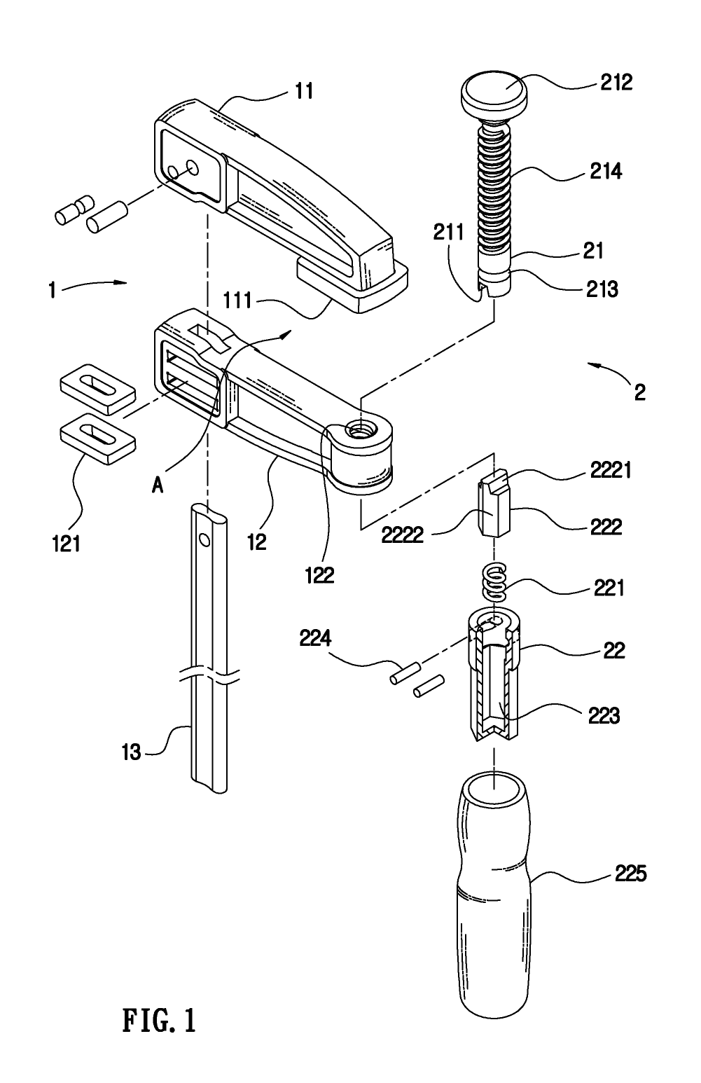

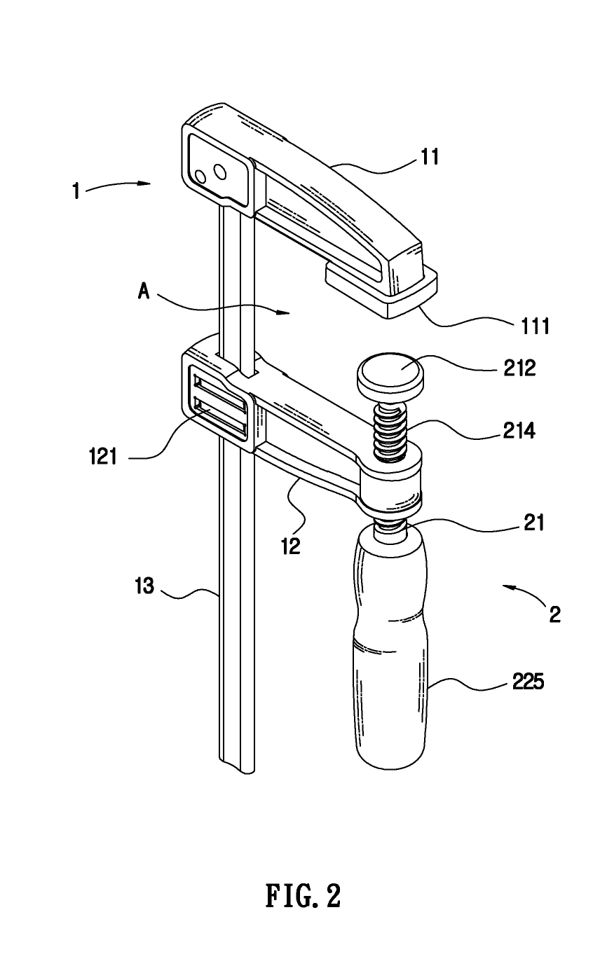

The present invention relates to a release structure for a fixture, and more particularly to a release structure for a fixture which has a prestress releasing device by which an excessive clamping force is buffered so as to prevent a clamp arm of the fixture or a clamped wooden workpiece from damage. With reference to FIGS. 1-5, a release structure for a fixture according to a first embodiment of the present invention comprises a support assembly 1 and a force mechanism 2.

The support assembly 1 includes a first support arm 11, a second support arm 12, and a connecting rod 13. The connecting rod 13 is inserted through one end of the first support arm 11 and one end of the second support arm 12, such that a clamping space A forms between the first support arm 11 and the second support arm 12 so as to place a wooden workpiece. The first support arm 11 has an abutting face 111 defined on a bottom surface of another end thereof and facing to the clamping space A.

The force mechanism 2 includes a screw post 21 screwing with another end of the second support arm 12 and a forcing post 22 fitted with and rotating relative to the screw post 21. The screw post 21 has a first inclined face 211 formed on a bottom end thereof so as to correspond to the forcing post 22 and has a clamp head 212 fixed on an top end thereof so as to mate with the wooden workpiece. The forcing post 22 has a resilient element 221 and a stop block 222, both of which are disposed in the forcing post 22 and abut against each other. The stop block 222 has a second inclined face 2221 defined on a top end thereof opposite to the resilient element 221 and meshing with the first inclined face 211 of the screw post 21.

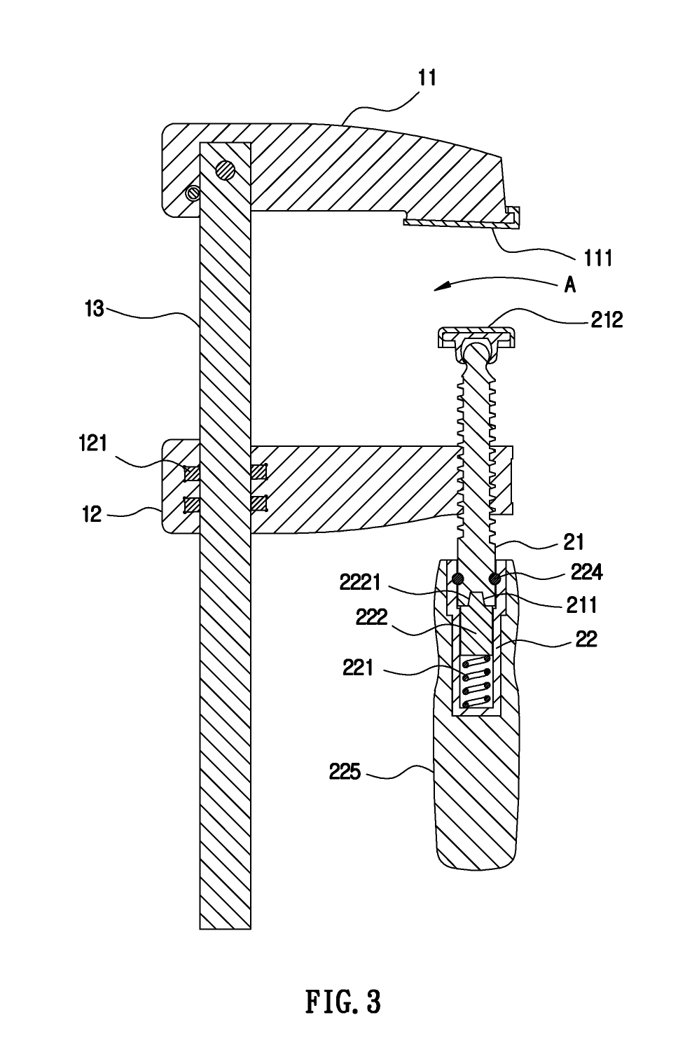

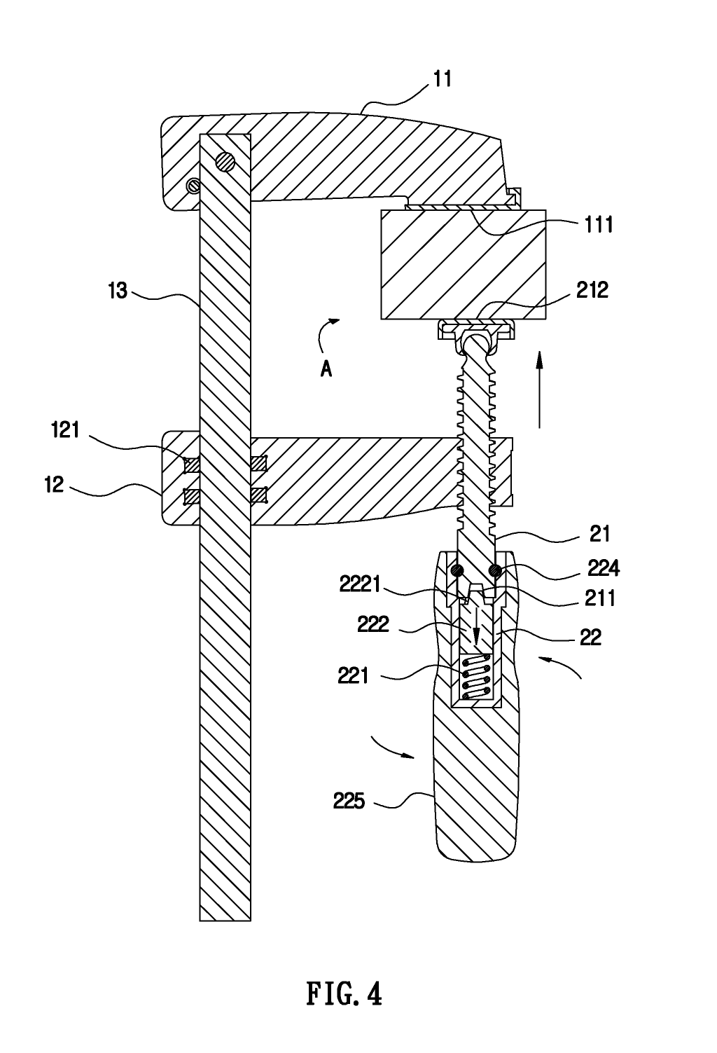

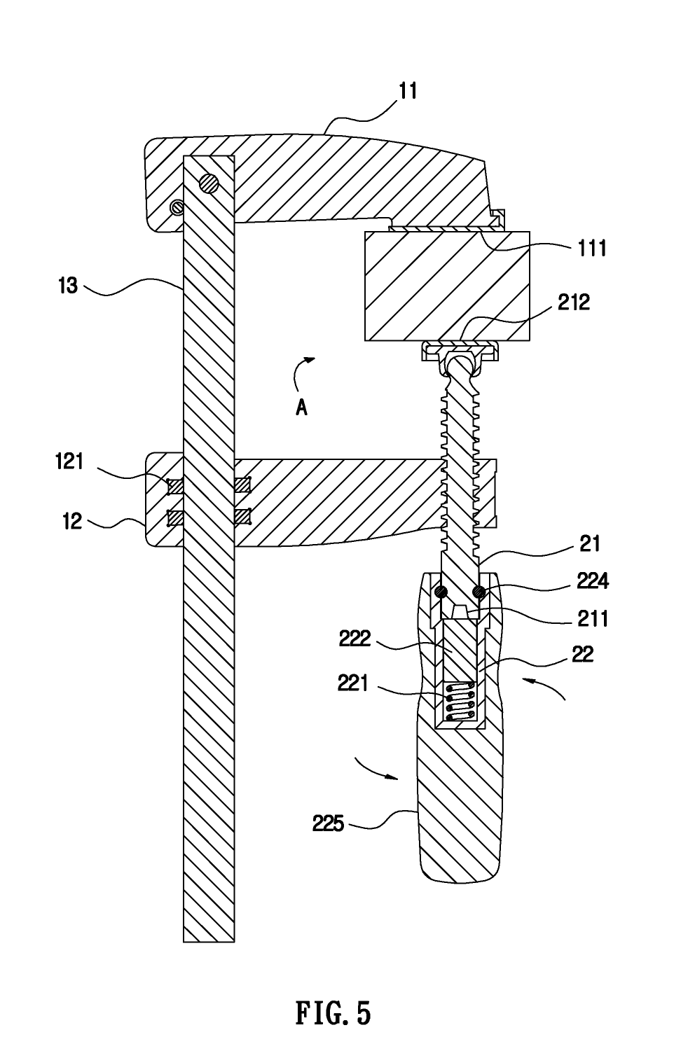

Thereby, when rotating the forcing post 22, the first inclined face 211 meshes with the second inclined face 2221 so as to drive the screw post 21 to move (as shown in FIG. 3), such that the clamping space A is pressed or released so as to clamp or unclamp the wooden workpiece. In addition, when an operation force is over a load range of the resilient element 221, the stop block 222 presses the resilient element 221 so that the first inclined face 211 disengages from the second inclined face 2221 (as illustrated in FIGS. 4 and 5), hence the screw post 21 stops clamping the wooden workpiece.

Preferably, the force mechanism 2 has a buffer effect by using the stop block 222 to press the resilient element 221 so that the forcing post 22 disengages from the screw post 21, and then the screw post 21 stops clamping the wooden workpiece, thus preventing the wooden workpiece from damage.

It is preferable that the forcing post 22 further has a polygonal groove 223 defined therein, and the stop block 222 has a polygonal face 2222 arranged around an outer peripheral wall thereof so as to correspond to the polygonal groove 223 of the forcing post 22, such that the stop block 222 is driven by the forcing post 22 as the forcing post 22 rotates in a horizontal direction, and as the stop block 222 presses the resilient element 221, a vertical movement of the forcing post 22 is not limited.

Preferably, the screw post 21 also has a peripheral recess 213 formed adjacent to the bottom end thereof, and the forcing post 22 also has at least one positioning bolt 224 for inserting through the peripheral recess 213 so that the screw post 21 is fixed by the at least one positioning bolt 224 without remove from the forcing post 22, but a rotation of the screw post 21 relative to the forcing post 22 is not interfered by the at least one positioning bolt 224.

Preferably, the forcing post 22 also has a handle sleeve 224 fitted therearound and made of plastic material so as to obtain an anti-slip function.

Furthermore, the second support arm 12 and the connecting rod 13 slide relative to each other. The second support arm 12 has at least one limit retainer 121 retained therein, and a caliber of the at least one limit retainer 121 is slightly over the connecting rod 13 so as to preserve a displacement tolerance which only produces as the second support arm 12 is perpendicular to the connecting rod 13, hence the second support arm 12 moves relative to the connecting rod 13. While operating the force mechanism 2 to clamp the wooden workpiece, the second support arm 12 tilts slightly so that the at least limit retainer 121 contacts with the connecting rod 13, and then the displacement tolerance disappears, thereafter the second support arm 12 is connected with the connecting rod 13 by ways of the at least limit retainer 121.

Preferably, the second support arm 12 further has a threaded hole 122 defined in another end thereof, and the screw post 21 has a threaded section 214 arranged between the top end and the bottom end thereof so as to screw with the threaded hole 122 of the second support arm 12, thus the screw post 21 is rotated to move along the second support arm 12.

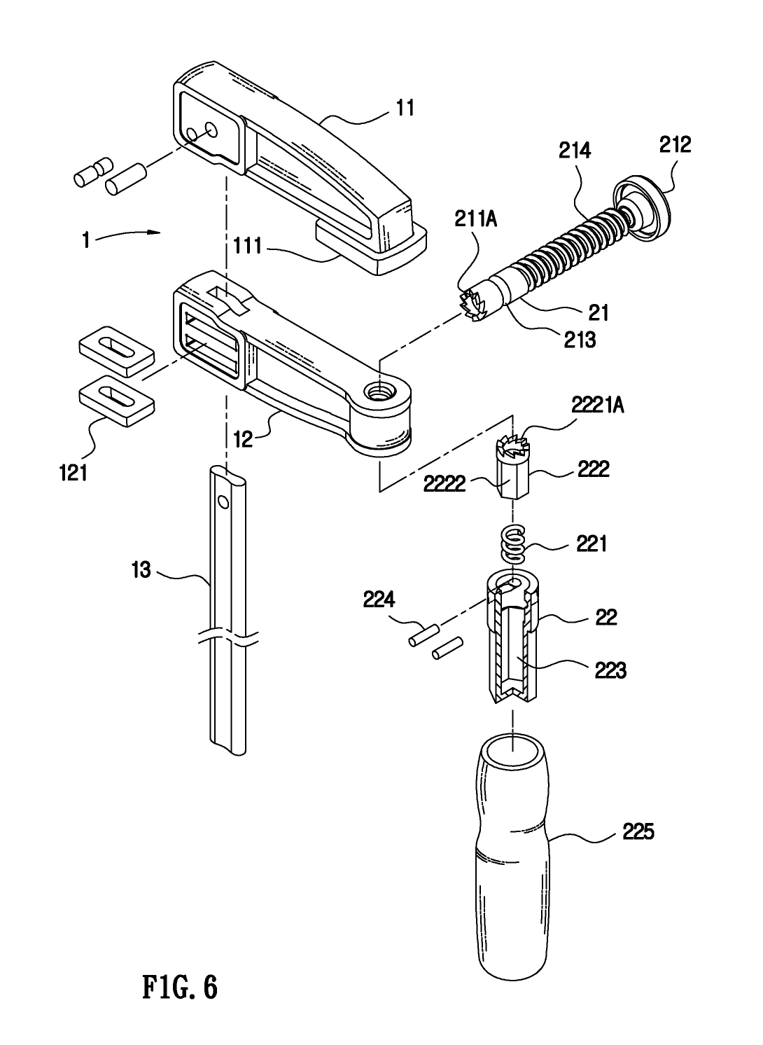

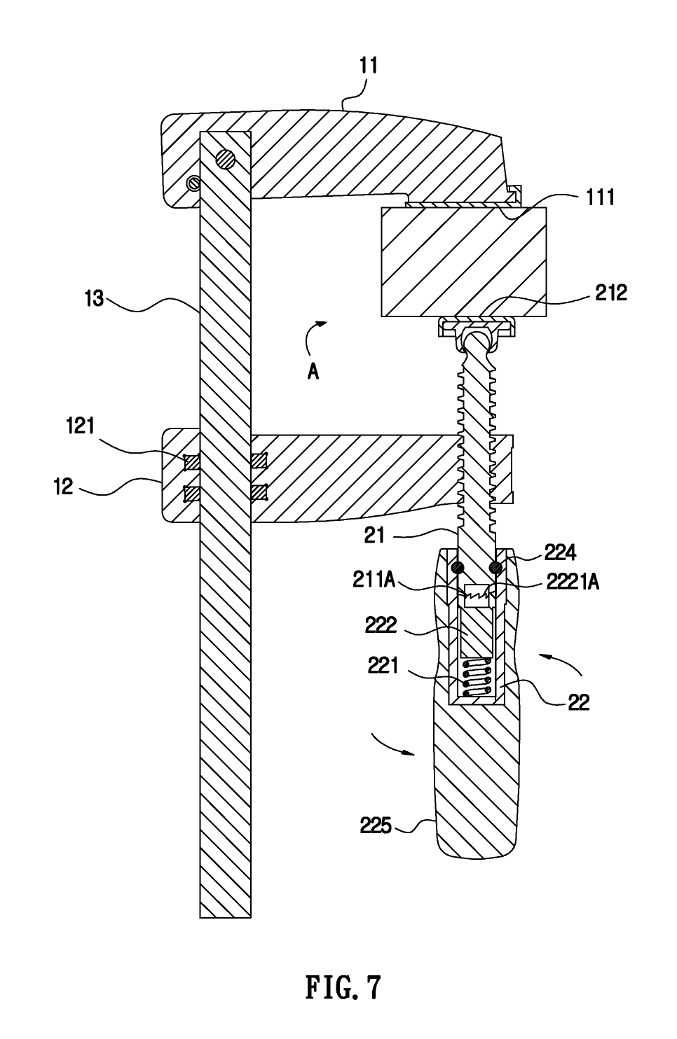

Referring further to FIGS. 6 and 7, a difference of a release structure for a fixture according to a second embodiment of the present invention from that of the first embodiment comprises a first inclined face 211A on which a first toothed portion is formed, and a second inclined face 2221A on which a second toothed portion is defined, wherein the first inclined face 211A engages with or disengages from the second inclined face 2221A of the stop block 222. When the second toothed portion disengages from the second toothed portion, the screw post 21 stops clamping the wooden workpiece, thereby preventing the wooden workpiece from damage.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A release structure for a fixture comprises:
a support assembly including a first support arm, a second support arm, and a connecting rod; the connecting rod being inserted through one end of the first support arm and one end of the second support arm, such that a clamping space forms between the first support arm and the second support arm so as to place a wooden workpiece, and the first support arm having an abutting face defined on a bottom surface of another end thereof and facing to the clamping space so as to abut against the wooden workpiece;
a force mechanism including a screw post screwing with another end of the second support arm and a forcing post fitted with and rotating relative to the screw post; the screw post having a first inclined face formed on a bottom end thereof so as to correspond to the forcing post and having a clamp head fixed on an top end thereof so as to mate with the wooden workpiece; the forcing post having a resilient element and a stop block, both of which are disposed in the forcing post and abut against each other; the stop block having a second inclined face defined on a top end thereof opposite to the resilient element and meshing with the first inclined face of the screw post;
thereby, when rotating the forcing post, the first inclined face meshes with the second inclined face so as to drive the screw post to move, such that the clamping space is pressed or released so as to clamp or unclamp the wooden workpiece, and when an operation force is over a load range of the resilient element, the stop block presses the resilient element so that the first inclined face disengages from the second inclined face, hence the screw post stops clamping the wooden workpiece.

2. The release structure for the fixture as claimed in claim 1, wherein the first inclined face is a first toothed portion, and the second inclined face is a second toothed portion defined, wherein the first toothed portion engages with or disengages from the second toothed portion of the stop block.

3. The release structure for the fixture as claimed in claim 1, wherein the screw post also has a peripheral recess formed adjacent to the bottom end thereof, and the forcing post also has at least one positioning bolt for inserting through the peripheral recess so that the screw post is fixed by the at least one positioning bolt without remove from the forcing post.

4. The release structure for the fixture as claimed in claim 1, wherein the second support arm and the connecting rod slide relative to each other, the second support arm has at least one limit retainer retained therein, and a caliber of the at least one limit retainer is slightly over the connecting rod so as to preserve a displacement tolerance which only produces as the second support arm is perpendicular to the connecting rod.

5. The release structure for the fixture as claimed in claim 1, wherein the forcing post also has a handle sleeve fitted therearound.

6. The release structure for the fixture as claimed in claim 1, wherein the second support arm further has a threaded hole defined in another end thereof, and the screw post has a threaded section arranged between the top end and the bottom end thereof so as to screw with the threaded hole of the second support arm.
